(19) United States
(12) Patent Application Publication
(10) Pub. No.: US 2009/0291299 A1
(43) Pub. Date: Nov. 26, 2009

(54) SELF-ADHESIVE FILM

(76) Inventors: Soo-Young Lee, Seongnam-si (KR); Kyoung-Cap Jeon, Seoul (KR); Sang-Young Yun, Cheonan-si (KR)

Correspondence Address: KED & ASSOCIATES, LLP, P.O. Box 221200, Chantilly, VA, 20153-1200, US

(21) Appl. No.: 12/470,851

(22) Filed: May 22, 2009

(30) Foreign Application Priority Data
May 26, 2008 (KR) 10-2008-0048365

(51) Int. Cl. C09J 7/02

(52) U.S. Cl. 428/352

(57) ABSTRACT

A self-adhesive film is provided. The self-adhesive film includes an adhesive surface layer containing an adhesive distributed from a surface to a first depth. The self-adhesive film has a much higher adhesive strength than conventional coating type adhesive tapes and leaves no adhesive residue on an adherend.

### BACKGROUND

1. Field

The present invention relates to a self-adhesive film. More specifically, the present invention relates to an adhesive film that has a higher adhesive strength than conventional coating type adhesive tapes, particularly leaves no adhesive residue on an adherend upon removal from the adherend, and uses no environmentally harmful substances (for example, solvents such as toluene) during its production.

2. Background

Generally, self-adhesive films refer to films that are repeatedly attachable to or detachable from adherends. Such self-adhesive films include polyethylene (PE) self-adhesive films, polypropylene (PP) self-adhesive films, ethylene vinyl acetate (EVA) self-adhesive films, polyethylene terephthalate (PET) self-adhesive films, wraps, etc. In addition to these, adhesive films of various base materials have been developed.

The molecular weights of conventional self-adhesive film materials make it difficult to achieve maximized adhesive strength of the self-adhesive films. In actuality, the conventional self-adhesive films have an adhesive strength as low as 3 g/inch, which limits their applications. Korea has imported some of the conventional films with a low adhesive strength from abroad. Further, attempts to produce films with an intermediate or high adhesive strength have not been successful worldwide. Under these circumstances, there is an urgent need to develop films with an intermediate or high adhesive strength.

### SUMMARY OF THE INVENTION

It is an object of the present invention to provide a self-adhesive film that can be repeatedly attached to an adherend and detached from the adherend without leaving any adhesive residue and whose adhesive strength can be controlled to a desired level, e.g., low, intermediate or high level.

In order to accomplish the above object of the present invention, there is provided a self-adhesive film including an adhesive surface layer containing an adhesive distributed from a surface to a first depth.

In an embodiment, the first depth at which the adhesive film shows most efficient adhesiveness may be 5 to 50% of the total thickness of the adhesive film.

In an embodiment, the adhesive may be a rubber or a mixture thereof with an unmodified acrylic adhesive.

In an embodiment, the adhesive strength of the adhesive film may be very easily controlled to an accurate value between 3 and 800 g/inch.

In an embodiment, the adhesive may have a concentration distribution shown in the graph of FIG. 2:

In an embodiment, the adhesive film may consist of at least one polyolefin film selected from polypropylene (PP), polyethylene (PE) and polyethylene terephthalate (PET) films.

In an embodiment, the adhesive surface layer and the portion other than the adhesive surface layer may be composed of different films.

In a preferred embodiment, the adhesive film may further include a surface release layer containing a release agent distributed from a surface opposite to the adhesive surface layer to a second depth. Due to the presence of the surface release layer, the adhesive film can be easily separated from another adhesive film or other material during its use.

In an embodiment, the second depth at which the adhesive film shows effective release performance may be 5 to 40% of the total thickness of the adhesive film.

In an embodiment, the release agent may include a rubber as a main material.

In an embodiment, the release agent may have a concentration distribution shown in the graph of FIG. 3:

In an embodiment, the surface release layer and the portion other than the surface release layer may be composed of different films.

### BRIEF DESCRIPTION OF THE DRAWINGS

These and/or other aspects and advantages of the invention will become apparent and more readily appreciated from the following description of the embodiments, taken in conjunction with the accompanying drawing of which:

FIG. 1 is a cross-sectional view schematically illustrating the structure of an adhesive film according to an embodiment of the present invention;

FIG. 2 is graph illustrating the concentration distribution of the adhesive; and

FIG. 3 is graph illustrating the concentration distribution of the release agent.

### DETAILED DESCRIPTION

Exemplary embodiments of the present invention will now be described in detail with reference to the accompanying drawing.

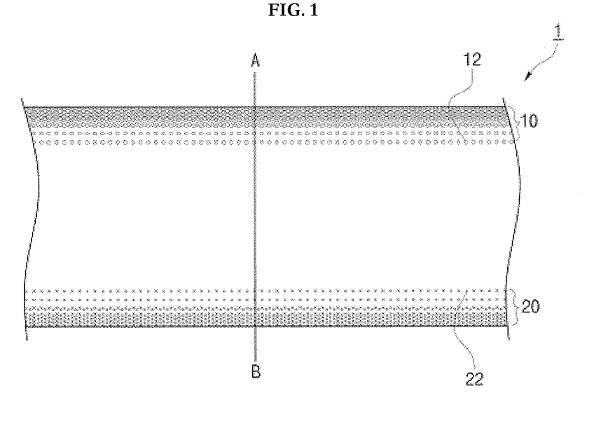

FIG. 1 schematically illustrates a cross-sectional view of a self-adhesive film 1 according to an embodiment of the present invention. As illustrated in FIG. 1, the adhesive film 1 includes an adhesive surface layer 10 and a surface release layer 20.

The adhesive surface layer 10 may be formed at a predetermined depth from a surface (‘first surface’) of the adhesive film 1. For example, the adhesive surface layer 10 may be formed at a first depth d1 from the first surface, as shown in Graph 1 that follows. The first depth d1 is a very important factor in achieving adhesiveness of the adhesive film. Thus, precise control of the first depth d1 is needed. It is preferred that the first depth d1 is controlled to about 5 to about 50% of the total thickness of the adhesive film 1. If the first depth d1 is below 5% of the total thickness of the adhesive film 1, the adhesiveness of the adhesive film 1 is too insignificant. Meanwhile, if the first depth d1 exceeds 50% of the total thickness of the adhesive film 1, the physical properties of the adhesive film 1 are deteriorate.

The adhesive surface layer 10 contains an adhesive 12 distributed therein. The adhesive 12 may be any suitable material. For example, a rubber alone or a mixture thereof with one or more other rubbers may be used as the adhesive 12.

The adhesive strength of the adhesive film may be varied. For example, the adhesive strength of the adhesive film is preferably controlled in the range of 3 to 800 g/inch. An adhesive strength lower than 3 g/inch is undesirable in terms of adhesiveness, and an adhesive strength higher than 800 g/inch is problematic in the release of the film.

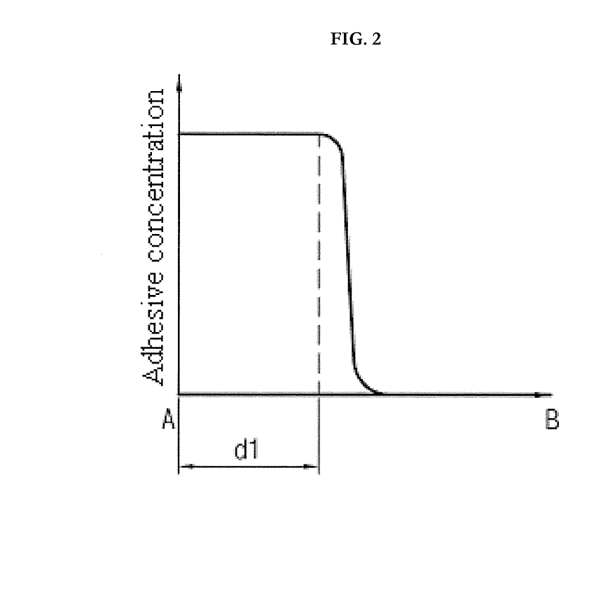

It is preferred that the adhesive 12 has a concentration distribution shown in the graph of FIG. 2:

According to the graph, the concentration of the adhesive 12 is maintained constant from the first surface of the adhesive film to the predetermined depth, i.e. the first depth d1, decreases steeply after the first depth d1, and finally reaches zero. The adhesive surface layer is defined as the portion from the first surface to the first depth d1 in which the adhesive concentration is maintained constant.

Various resins may be used as materials for the adhesive film. Examples of suitable resins include polypropylene (PP), polyethylene (PE), polyethylene terephthalate (PET) and mixtures thereof.

The adhesive film may be formed of one resin. Alternatively, the adhesive surface layer and the portion other than the adhesive surface layer may be formed of different resins. For example, the adhesive surface layer 10 may be formed of a polypropylene (PP) resin and the other portion may be formed of a polyethylene (PE) resin. The reason why the adhesive surface layer 10 and the other portion are formed of different resins is to ensure uniform blending of the adhesive and easy molding of the adhesive film.

Although the adhesive surface layer 10 is divided from the other portion in FIG. 1, the interface may be indiscernible, making it impossible to clearly distinguish the adhesive surface layer 10 and the other portion of the adhesive film. That is, the adhesive decreases continuously with increasing depth and disappears completely at a given depth, but the depth at which the adhesive disappears may be varied depending on the site of the adhesive film. In the case where different resins are used to form the adhesive surface layer and the other portion of the adhesive film, they are mixed at the interface, and as a result, the interface is not discernable, making it impossible to clearly distinguish the adhesive surface layer 10 and the other portion of the adhesive film.

The surface release layer 20 refers to a portion in which a release agent 22 is distributed from a surface opposite to the adhesive surface layer 10 to a second depth d2. The surface release layer 20 may be omitted if desired, but there is a need to form the surface release layer 20 in order to prevent the adhesive film from being attached to another adhesive film with increasing adhesive strength.

Similarly to the adhesive surface layer, the surface release layer 20 of the adhesive film 1 has a structure in which the release agent is distributed. Due to this structure, the release agent is not exposed outside or does not escape from the adhesive film during use.

The second depth d2 at which the release agent 22 is distributed is preferably 5 to 40% of the total thickness of the adhesive film 1. If the second depth d2 is below 5% of the total thickness of the adhesive film 1, the release performance of the surface release layer is not satisfactorily exhibited. Meanwhile, if the second depth d2 is above 40% of the total thickness of the adhesive film 1, it is difficult to produce the adhesive film by molding.

The release agent 22 may be any suitable material. For example, the release agent 22 may be a silicone material or a mixture thereof with one or more other silicone materials.

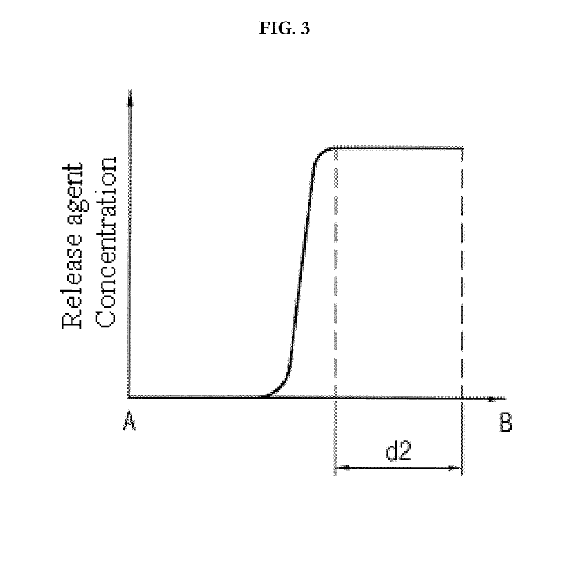

The release agent 22 may have a concentration distribution shown in the graph of FIG. 3.

That is, similarly to the adhesive surface layer 10, the concentration of the release agent 22 is maintained constant from a surface opposite to the adhesive surface layer 10 to the predetermined depth, i.e. the second depth d2, decreases steeply after the second depth d2, and finally reaches zero. The second depth d2, at which the release agent is maintained constant, is of great importance. The second depth d2 is preferably 5 to 40% of the total thickness of the adhesive film.

Like the adhesive surface layer 10, the surface release layer 20 may be formed of the same resin as the portion other than the surface release layer 20. Alternatively, the surface release layer 20 and the other portion may be formed of different resins. That is, the adhesive film may have a structure consisting of three layers, i.e. the adhesive surface layer 10, the surface release layer 20 and the other portion, formed of different resins.

As is apparent from the above description, since the adhesive film of the present invention contains the adhesive distributed therein, it can be repeatedly used without leaving any adhesive residue on an adherend.

Further, the adhesive strength of the adhesive film according to the present invention is freely controllable by varying the concentration and kind of the adhesive used. Particularly, a very high adhesive strength of the adhesive film according to the present invention can be achieved.

Further, the adhesive film of the present invention can be recycled in various ways after use because the adhesive and the release agent are distributed therein.

Further, the adhesive film of the present invention is environmentally friendly and does not negatively affect the environment and human health because it uses no environmentally harmful substances (solvents, such as toluene, plasticizers, etc) during production.

Further, the adhesive contained in the adhesive film of the present invention does not undergo modification by UV irradiation and temperature change, unlike adhesives of conventional adhesive tapes. Therefore, the adhesive film of the present invention can be used in industrial applications to which conventional adhesive tapes could not have been applied.

What is claimed is:

1. A self-adhesive film comprising an adhesive surface layer containing an adhesive distributed from a surface to a first depth and a surface release layer containing a release agent distributed from a surface opposite to the adhesive surface layer to a second depth.

2. The self-adhesive film of claim 1, wherein the first depth is 5 to 50% of the total thickness of the adhesive film.

3. The self-adhesive film of claim 1, wherein the adhesive is a rubber or a mixture thereof with an unmodified acrylic adhesive.

4. The self-adhesive film of claim 1, wherein the adhesive film has an adhesive strength between 3 and 800 g/inch.

5. The self-adhesive film of claim 1, wherein the adhesive has a concentration distribution shown in Graph 1:

[symbol]

6. The self-adhesive film of claim 1, wherein the adhesive film is composed of a polymer selected from polypropylene (PP), polyethylene (PE) and polyethylene terephthalate (PET).

7. The self-adhesive film of claim 1, wherein the adhesive surface layer and the portion other than the adhesive surface layer are composed of different films.

8. The self-adhesive film of claim 1, wherein the release agent has a concentration distribution shown in Graph 2:

[symbol]

9. The self-adhesive film of claim 1, wherein the second depth is 5 to 40% of the total thickness of the adhesive film.
